(19) United States
(12) Patent Application Publication
(10) Pub. No.: US 2002/0038343 A1
(43) Pub. Date: Mar. 28, 2002

(54) Process for supplying a web site designer or web site host type customer with a tool for transforming an image from a first format into a second format

(75) Inventor: Eric Masera, Paris (FR)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 09/962,522

(22) Filed: Sep. 25, 2001

(30) Foreign Application Priority Data
Sep. 28, 2000 (FR) 0012330

(51) Int. Cl. G06F 15/16

(52) U.S. Cl. 709/203; 709/246

(57) ABSTRACT

The present invention relates to a process to supply a web site designer or web site host type customer with a tool for transforming an image from a first format into a second format. This permits the web site designer or host type customer to transform the images present on their web site and stored in a unique format, into a second format suited to the display screen of a site user's terminal.

### FIELD OF THE INVENTION

The present invention relates to a tool for transforming an image from a first format into a second format, and more particularly to a process for supplying such a tool to a web site designer or web site host type customer.

### BACKGROUND OF THE INVENTION

The worldwide web is currently accessible through many types of apparatuses such as for instance a PC or a mobile telephone. The various sites accessible on the web comprise display information that is of a multimedia type, i.e., images, text and sound. The various existing apparatuses for accessing these sites have very varied technical capacities in terms of memory and display. Thus, the types of file and the size of images displayable on the apparatuses vary according to their capacities. Web site designers or again web site hosts have to plan for different types of format and image size in their site if they want all users to be able to view their site with any type of apparatus.

### SUMMARY OF THE INVENTION

An object of the present invention is to provide a process that aims to supply a web site designer or web site host type customer with a tool that enables them to only need a single format and a single image size for their site images, while enabling the site users to view them from any viewing apparatus. Within the context of the present invention, the term “web” refers to a remotely accessible network or networks which are independent or interconnected.

The present invention relates to a process for supplying a web site designer or web site host type customer with a tool for transforming an image from a first format to a second format to transform the images present on their site and stored in a unique format, into a second format suited to the display screen of a site user's terminal. The process comprises the following steps:

from a request coming from a user of the customer's site, in which the user requests to view, on his/her terminal, a page of the site in which is found at least one image, to identify the address at which the customer has stored the image in the unique format;

to recover the image from the identified address;

to determine the image format suited to the user's terminal on which the image is to be displayed;

to apply a transformation to the recovered image so as to transform it into the set format;

to reconstitute and transmit the image, transformed into the set format, to the user.

More specifically, the present invention relates to a process for supplying a web site customer with a tool for transforming an image on a web site from a first format to a second format, wherein the second format is suitable for display on a display screen of a terminal accessed by user of the web site. The process comprises the steps of: identifying an address at which the web site customer has stored an image in a first format in response to a request by a user of the web site, in which the user requests to view, on his/her terminal, a page of the web site in which is found at least one image including the stored image; recovering the stored image at the identified address; determining an image format suited to the user's terminal on which the recovered stored image is to be displayed; applying a transformation to the recovered stored image so as to transform the recovered stored image into a second format suited to the user's terminal; and reconstituting and transmitting the recovered stored image, transformed into the second format, to the user.

### BRIEF DESCRIPTION OF THE DRAWINGS

Other characteristics will appear on reading the description that follows, making reference to the drawings wherein:

FIG. 1 represents a process according to the present invention;

FIG. 2 represents a first embodiment of the process according to the invention;

FIG. 3 represents a second embodiment;

FIG. 4 represents a third embodiment; and

FIG. 5 represents a particular embodiment of the invention.

### DETAILED DESCRIPTION OF THE INVENTION

In the description that follows, the terms defined in the manner below will be used. The term “image format” refers to the size of images as well as their file type. The term “customer” refers to a web type site designer or the host of such a site. The term “user” refers to a person viewing a web type site

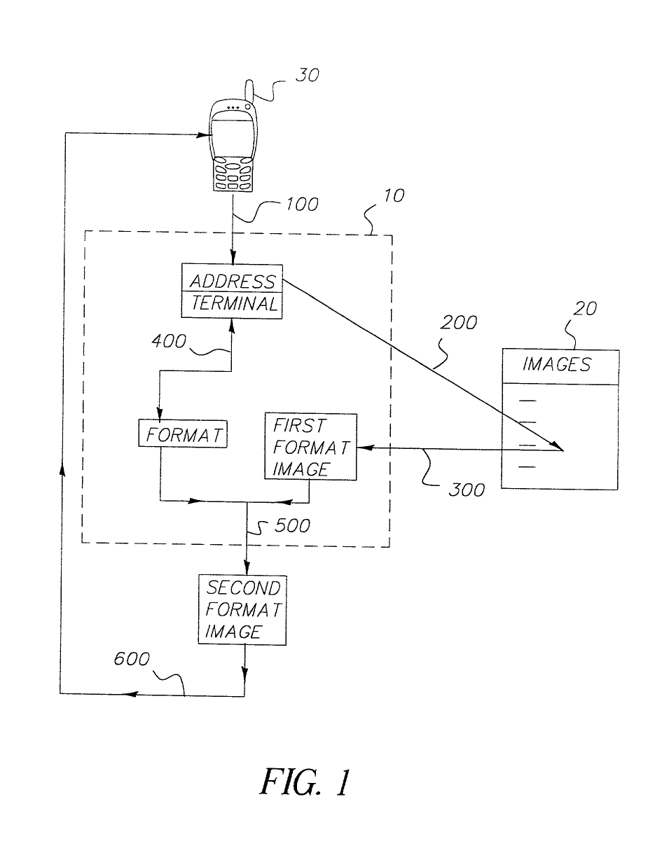

The process of the invention illustrated in FIG. 1, provides that each customer stores images 20 of its site 10 on a server that can be managed by itself or by a third party. According to the invention, the customer stores each of its images 20 in a unique format. Preferably, the chosen format must contain sufficient information to enable a later conversion. The format contains information relating to the definition of the image, the size of the image, or the color.

When a site user wants to view on his/her terminal 30 a page in which is found at least one image, a request 100 is emitted in which the terminal 30 used is identified (by, for example, its address) as well as the image(s) of the site page that the customer wants to view. For each image, one http type request, or again transformed into http by a gateway, is made on a program that states 200 the URL address defined on the server in which it has been stored. Then the program recovers 300 the image at the URL address given. The image format suited to the user's terminal 30 on which the image is to be displayed is then determined 400.

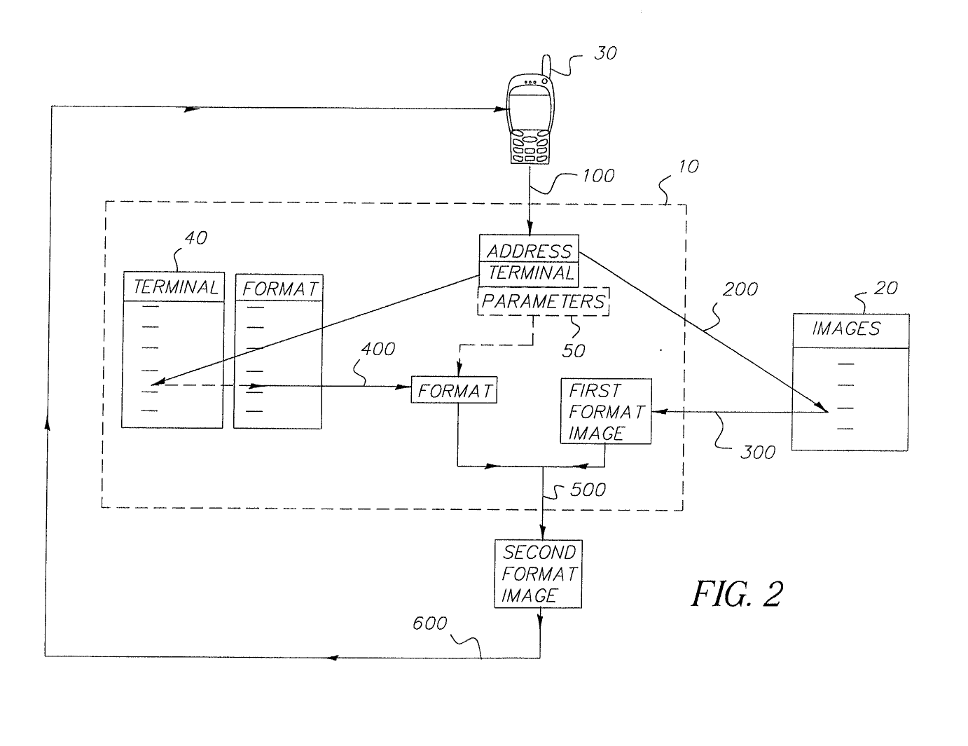

For this purpose, according to a first embodiment illustrated in FIG. 2, it is planned to manage a database 40 comprising a list of different types of terminals with display screens. The different types of terminals are, for example, a personal computer, a mobile phone equipped with a display screen, a PDA, or any other type of apparatus by means of which a web type site can be viewed. The database 40 also comprises the format(s) of images that can be displayed on each type of terminal listed in the database. For instance, it can be planned that the management of this database comprises manually adding every new type of terminal appearing on the market as well as the image format(s) displayable on it. It can also be planned for this database to be manually updated when a request has not enabled recognition of the terminal used. According to this first embodiment, the image format suited to the user's terminal 30 on which the image is to be displayed is determined 400 from the database 40.

According to a variant of this embodiment, formatting parameters 50 (FIG. 2) of the image linked to the output format can be detailed in the request 100 coming from the terminal, for instance, when the user's terminal is capable of displaying images of different formats. These parameters relate to, for example, the image height or width. If no formatting parameter 50 is stated, default parameters are used.

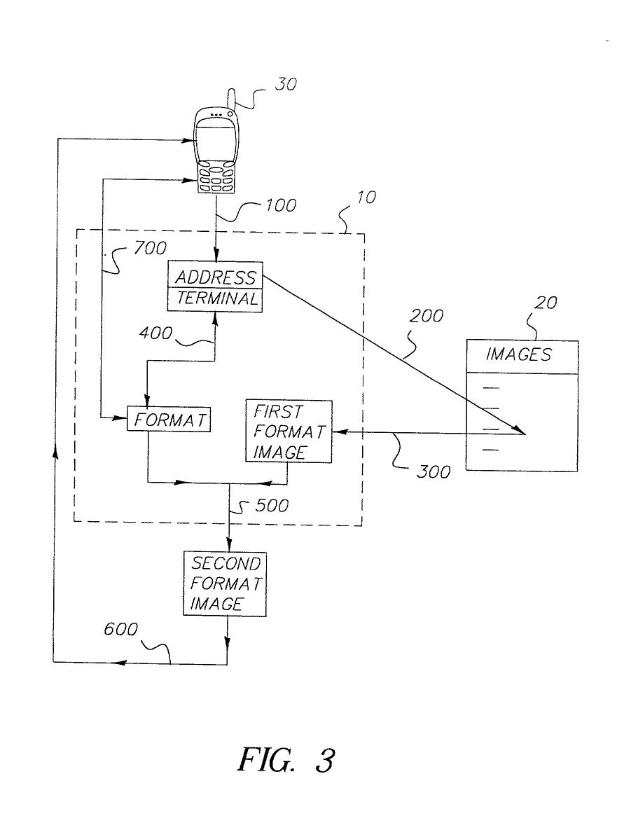

According to a second embodiment illustrated in FIG. 3, a request 700 can be transmitted to the user's terminal to request the terminal's display capacities. The image format suited to the terminal is determined according to the identified capacities.

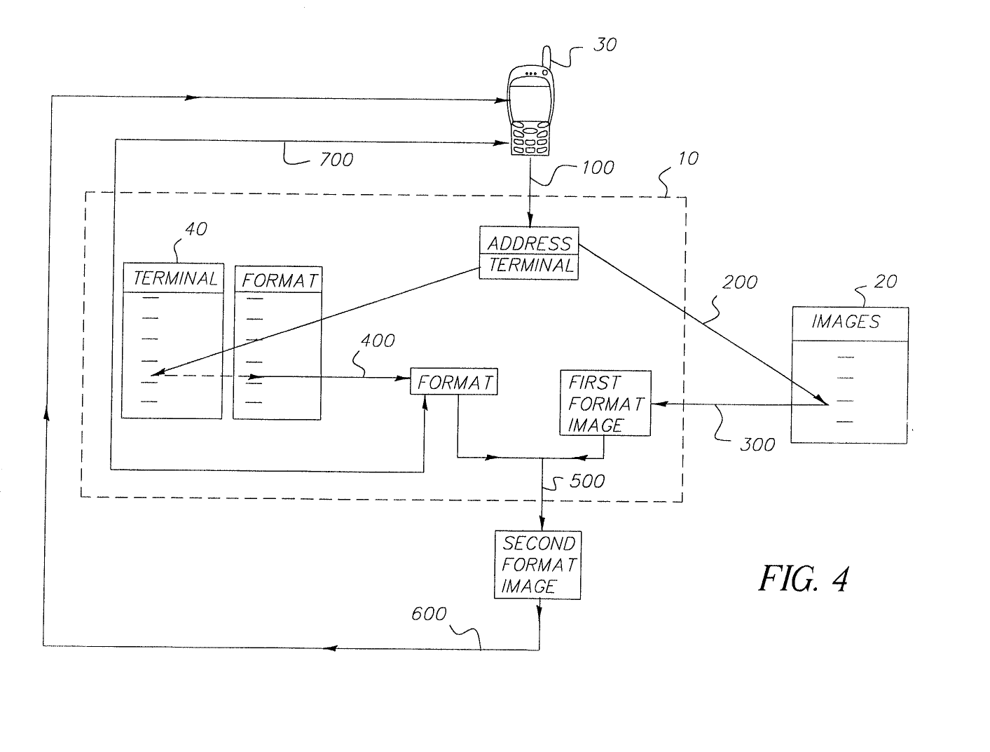

According to a third embodiment represented in FIG. 4, the image format suited to the terminal can be determined according to both the database 40 and the terminal display capacities identified following the request 700 to the terminal.

Then a conversion program transforms 500 the image into the set format (first image format to second image format), for example JPEG or again WBMP (wireless bitmap) when the identified terminal is a cell phone and the viewing application is a Browser Wap (wireless application protocol) 1.1 type.

For instance, when a request comes from a cell phone with a Browser Wap 1.1 type application, without specific formatting parameter, the image is loaded from the identified URL address, image filtering is applied to optimize its quality, and the image is converted to the WBMP format. According to another example, when the request comes from a PC in which a size parameter has been specified, e.g. 200×150, the image is loaded from the identified URL address; it is set to scale 200×150 and converted to the JPEG format.

Once the image is transformed into the required format, the image is reconstituted and transmitted 600 to the user on the fly, i.e. instantaneously.

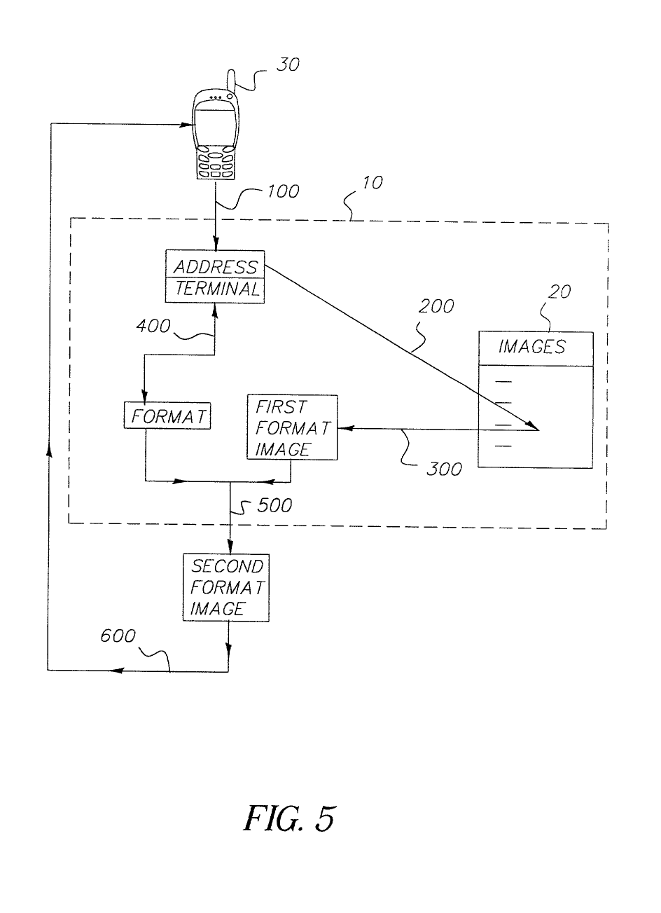

According to a particular embodiment of the invention represented in FIG. 5, it is also planned to manage the storage of the site images in the unique format.

Thus, a customer will only have to supply the same service provider with all the images of its site, in a unique format, and the provider will make the transformations necessary to correctly reconstitute and transmit the images to the customer, as well as, if necessary, storing the images.

The invention has been described in detail with particular reference to certain preferred embodiments thereof, but it will be understood that variations and modifications can be effected within the spirit and scope of the invention.

1. A process for supplying a web site customer with a tool for transforming an image on a web site from a first format to a second format, wherein the second format is suitable for display on a display screen of a terminal accessed by a user of the web site, the process comprising the steps of:
identifying an address at which the web site customer has stored an image in a first format in response to a request from a user of the web site, in which the user requests to view, on his/her terminal, a page of the web site in which is found at least one image including the stored image;
recovering the stored image at the identified address;
determining an image format suited to the user's terminal on which the recovered stored image is to be displayed;
applying a transformation to the recovered stored image so as to transform the recovered stored image into a second format suited to the user's terminal; and
reconstituting and transmitting the recovered stored image, transformed into the second format, to the user.

2. A process according to claim 1, further comprising the step of
managing a database in which are associated different types of terminals with display screens and image format or formats displayable on the screens, an image format suited to the terminal being determined from the database.

3. A process according to claim 1, further comprising transmitting a request to the user's terminal for display capacities of the terminal, such that the second format suited to the terminal is determined according to the display capacities.

4. A process according to claim 2, further comprising transmitting a request to the user's terminal for display capacities of the terminal, such that the second format suited to the terminal is further determined according to the display capacities.

5. A process according to claim 2, further comprising determining the second format suited to the user's terminal on which the image is to be displayed according to formatting parameters of the stored image requested by the user.

6. A process according to claim 1, further comprises the step of storing all of the images present on the customer's web site.
